(19) United States
(12) Patent Application Publication
(10) Pub. No.: US 2007/0120545 A1
(43) Pub. Date: May 31, 2007

(54) DC/DC CONVERTER

(76) Inventors: Takehiro HATA, Tokyo (JP); Shinichi Yoshida, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/562,551

(22) Filed: Nov. 22, 2006

(30) Foreign Application Priority Data
Nov. 25, 2005 (JP) 2005-339569

(51) Int. Cl. G05F 1/00

(52) U.S. Cl. 323/282

(57) ABSTRACT

The present invention aims to share a semiconductor chip built-in circuit for a step-down function and a step-up function by or through one semiconductor product used as a DC/DC converter configured in a semiconductor chip. The semiconductor chip includes a switching driver, a first switch element and a second switch element. An output current path of the first switch element and an output current path of the second switch element are connected in series. A common connecting point of the first and second switch elements is connected to one end of a smoothing coil outside the semiconductor chip, and the output current path of the second switch element is connected to a base potential. An input DC voltage is supplied from the first switch element, and a step-down voltage VOUT to a load is outputted from the other end of the coil. When a method of supplying the input DC voltage and a method of performing a connection to the load are changed, a step-up voltage is outputted.

### CROSS-REFERENCE TO RELATED APPLICATION

The present application claims priority from Japanese patent application No. 2005-339569 filed on Nov. 25, 2005, the content of which is hereby incorporated by reference into this application.

### BACKGROUND OF THE INVENTION

The present invention relates to a DC/DC converter which converts the level of a DC voltage, and a technique useful for enabling step-down and step-up and particularly enabling a high-efficiency operation.

As a DC/DC converter capable of generating an output DC voltage lower than an input DC voltage or generating an output DC voltage higher than the input DC voltage, there has heretofore been known a chopper switching regulator described in a non-patent document 1 (“Handbook for electronics and communication engineers”, First Edition, Fourth Printed Publication, PP. 721--722, Aug. 20, 1979, Ohmsha Ltd.).

As its choppers, may be mentioned, a step-down chopper and a step-up chopper.

The step-down chopper supplies an input DC voltage VIN to the collector of a switching transistor, connects one end of a smoothing coil and the cathode of a diode to the emitter of the switching transistor, and parallel-connects a smoothing capacitor and a load to the other end of the smoothing coil. An output DC voltage VOUT of such a parallel connection becomes a value lower than the input DC voltage VIN as expressed in the following equation, based on an on period TON and an off period TOFF.
VOUT=VIN·TON/(TON+TOFF) (1)

On the other hand, the step-up chopper connects a smoothing coil between an input DC voltage VIN and the collector of a switching transistor, connects the anode of a diode to the collector of the switching transistor, and parallel-connects a smoothing capacitor and a load to the cathode of the diode. An output DC voltage VOUT of such a parallel connection becomes a value higher than the input DC voltage VIN as expressed in the following equation, based on an on period TON of the switching transistor and an off period TOFF thereof.
VOUT=VIN·(TON+TOFF)/OFF (2)

On the other hand, a switching regulator has been known by the following patent document 1 (Japanese Unexamined Patent Publication No. 2004-64994) as a power supply circuit which forms a stabilized output dc voltage from a nonstabilized input dc voltage. The switching regulator supplies a current from a supply voltage corresponding to an input dc voltage non-stabilized during a first period in one switching operation cycle to a smoothing coil of a low-pass filter via a switch on the supply voltage side, which has been brought to an on state. During a second period subsequent to the elapse of the first period in the one switching operation cycle, a switch on the base potential side is turned on while the switch on the supply voltage side is brought to an off state. In doing so, a regenerative current caused by energy stored in the smoothing coil flows from the base potential through the switch on the base potential side, which is held in an on state. When the one switching operation cycle is repeated plural times, a stabilized output dc voltage is obtained from a load and a smoothing capacitor parallel-connected thereto.

Further, the patent document 1 describes the technique of allowing an output voltage of a switching regulator to follow an early stabilized output dc voltage at high speed even upon a variation in load due to a variation in current flowing through the load driven by the output voltage. In order to reduce a loss of power, the resistor placed in series with the smoothing coil for detecting the current flowing through the load or the smoothing coil is eliminated. As an alternative to it, a series connected circuit of a resistor and a capacitor is connected in parallel with a smoothing coil of a series regulator. The potential at a node where the resistor and capacitor of the series connected circuit is inputted to a comparator circuit having a hysteresis characteristic. An early object is achieved by on/off-controlling the switch on the supply voltage side using the output of the comparator circuit.

### SUMMARY OF THE INVENTION

The present inventors have carried out further investigations on the arts described in the non-patent document 1 and the patent document 1. As a result, the present inventors have led to the following conclusion.

In the art described in the non-patent document 1, an output DC voltage lower than an input DC voltage can be generated if the circuit format of the step-down chopper is adopted. Similarly, if the circuit format of the step-up chopper is adopted, then an output DC voltage higher than an input DC voltage can be generated. In the art of the switching regulator described in the patent document 1, an output DC voltage lower than an input DC voltage can be produced because of the circuit format of the step-down chopper. In the present art, however, an output DC voltage higher than the input DC voltage cannot be generated.

In particular, each of a DC/DC converter and a switching regulator has recently adopted a semiconductor integrated circuit technique and built in a semiconductor chip, not only a plurality of switching transistors but also a switching driver circuit for on/off-controlling the plural switching drivers. Thus, the DC/DC converter and the switching regulator are reduced in cost and their compact sizes are realized.

It has however been manifested by the investigations of the present inventors that the arts described in the non-patent document 1 and the patent document 1 have led to the conclusion that consideration of allowing a semiconductor chip built-in circuit to be shared for a step-down function and a step-up function by or through one semiconductor product used as each of the DC/DC converter and the switching regulator configured in the semiconductor chip is insufficient.

It has been revealed by the investigations of the present inventors that the arts have led to the conclusion that consideration as to how a load variation detection circuit for detecting a variation in load and allowing an output DC current to respond at high speed is shared is insufficient upon realizing a step-down function and a step-up function.

A first present invention has been made based on the above investigations done by the present inventors. An object of the first present invention is to share a semiconductor chip built-in circuit for a step-down function and a step-up function by one semiconductor product used as a DC/DC converter configured in a semiconductor chip. Another object of the first present invention is to share a load variation detection circuit for detecting a variation in load and allowing an output DC current to respond at high speed, upon realizing a step-down function and a step-up function.

While the patent document 1 has the feature that the switching frequency changes with the variation in load current, the problem of increasing the amount of change in switching frequency and making it difficult to eliminate noise has been manifested by the investigations of the present inventors. It has also been revealed by the investigations of the present inventors that this noise exerts a bad influence on a system using a DC/DC converter and a switching regulator.

A second present invention has been made based on the above investigations of the present inventors. An object of the second present invention is to improve a response characteristic and a noise characteristic with respect to a variation in load current in a DC/DC converter.

The above, other objects and novel features of the present invention will become apparent from the description of the present specification and the accompanying drawings.

Summaries of typical or representative ones of the inventions disclosed in the present application will briefly be explained as follows:

A semiconductor chip for constituting a DC/DC converter according to one embodiment of a first present invention includes a switching driver (DRV), and a first switch element (M1) and a second switch element (M2) driven by the switching driver (DRV). An output current path of the first switch element (M1) and an output current path of the second switch element (M2) are connected in series. A common connecting point of the first switch element (M1) and the second switch element (M2) is adapted so as to be connected to one end of a smoothing coil (L) outside the semiconductor chip. The output current path of the second switch element (M2) is adopted so as to be connected to a base potential (refer to FIGS. 1 and 2).

In a mode in which the DC/DC converter performs a step-down operation, a smoothing capacitor (C1) and a load (ZL) are parallel-connected to the other end of the smoothing coil (L) outside the semiconductor chip. In the step-down operation mode, the output current path of the first switch element (M1) is supplied with an input DC voltage (VIN) outside the semiconductor chip (refer to FIG. 1).

In a mode in which the DC/DC converter performs a step-up operation, the other end of the smoothing coil (L) is supplied with the input DC voltage (VIN) outside the semiconductor chip. In the step-up operation mode, the smoothing capacitor (C1) and the load (ZL) are parallel-connected to the output current path of the first switch element (M1) outside the semiconductor chip (refer to FIG. 2).

In a mode in which the DC/DC converter performs a step-down operation, the switching driver (DRV) controls the first switch element (M1) to an on state and controls the second switch element (M2) to an off state during a first period. Thus, current is supplied to a parallel connection of the smoothing capacitor (C1) and the load (ZL) from the input DC voltage (VIN) via the first switch element (M1) and the smoothing coil (L) during the first period, and energy is hence stored in the smoothing coil (L) during the first period. During a second period subsequent to the first period, the switching driver (DRV) controls the first switch element (M1) to an off state and controls the second switch element (M2) to an on state. Thus, a regenerative current used as an energy release current flows from the base potential via the second switch element (M2) and the smoothing coil (L) during the second period. Therefore, a voltage drop dependent on the ratio between the second period and the first period is developed, and hence the DC/DC converter performs the step-down operation (refer to FIG. 1).

In a mode in which the DC/DC converter performs a step-up operation, the switching driver (DRV) controls the first switch element (M1) to an off state and controls the second switch element (M2) to an on state during a first period. Thus, current flows from the input DC voltage (VIN) to the base potential via the second switch element (M2) and the smoothing coil (L) during the first period, and energy is hence stored in the smoothing coil (L) during the first period. During a second period subsequent to the first period, the switching driver (DRV) controls the first switch element (M1) to an on state and controls the second switch element (M2) to an off state. Thus, a regenerative current used as an energy release current flows from the input DC voltage (VIN) to the parallel connection of the smoothing capacitor (C1) and the load (ZL) via the smoothing coil (L) and the first switch element (M1) during the second period. Thus, a voltage obtained by superimposing released energy on the input DC voltage (VIN) is supplied to the parallel connection during the second period. Therefore, a voltage increase dependent on the ratio between the second period and the first period is developed, and hence the DC/DC converter performs the step-up operation (refer to FIG. 2).

According to the above means according to the first present invention, the connection form between the input DC voltage (VIN) and the parallel connection of the smoothing capacitor (C1) and the load (ZL) at the outside of the semiconductor chip is changed, and the switching operation of the switching driver (DRV) is further changed. Thus, according to the means according to the first present invention, the switching driver (DRV), the first switch element (M1) and the second switch element (M2) lying inside the semiconductor chip can contribute to both the step-down and step-up operations (refer to FIGS. 1 and 2).

In addition, a specific form of the first present invention further includes a feedback circuit (FBC) which detects a variation in current flowing through the smoothing coil (L). The feedback circuit (FBC) includes a feedback capacitor (Cf) having one end supplied with a DC output voltage (VOUT) supplied to the load (ZL), a first feedback resistor (Rf1) having one end connected to the other end of the feedback capacitor (Cf), and a second feedback resistor (Rf2) having one end connected to the other end of the feedback capacitor (Cf). An output voltage detected by the feedback circuit (FBC) is obtained from a common connecting point of the feedback capacitor (Cf), the first feedback resistor (Rf1) and the second feedback resistor (Rf2), and the detected output voltage (Vfb) is fed back to the input (DRV_In) of the switching driver (DRV).

In the mode in which the DC/DC converter performs the step-down operation, a signal related to the input (DRV_In) of the switching driver (DRV) is supplied to the other end of the first feedback resistor (Rf1), and a base potential is supplied to the other end of the second feedback resistor (Rf2). In the mode in which the DC/DC converter performs the step-up operation, a signal related to the input (DRV_In) of the switching driver (DRV) is supplied to the other end of the first feedback resistor (Rf1), and a signal related to the input DC voltage (VIN) is supplied to the other end of the second feedback resistor (Rf2).

A DC/DC converter according to one embodiment of a second present invention includes a switching driver (DRV), and a first switch element (M1) and a second switch element (M2) driven by the switching driver (DRV). An output current path of the first switch element (M1) and an output current path of the second switch element (M2) are connected in series. A common connecting point of the first switch element (M1) and the second switch element (M2) are adapted so as to be connected to one end of a smoothing coil (L). An input DC voltage (VIN) is supplied to the output current path of the first switch element (M1). The output current path of the second switch element (M2) is adapted so as to be connected to a base potential. A smoothing capacitor (C1) and a load (ZL) are parallel-connected to the other end of the smoothing coil (L). The DC/DC converter further includes an error amplifier (EA), a feedback circuit (FBC), a comparator (CMP), and a latch (FF). The error amplifier (EA) detects an error of an output DC voltage (VOUT) supplied to the parallel connection of the smoothing capacitor (C1) and the load (ZL). The feedback circuit (FBC) includes a feedback capacitor (Cf) having one end connected to the other end of the smoothing coil (L), and a feedback resistor (Rf) having one end connected to the other end of the feedback capacitor (Cf) and the other end connected to the one end of the smoothing coil (L). The comparator (CMP) compares a signal that responds to the output of the error amplifier (EA) and an output signal of the feedback circuit (FBC). The latch (FF) is set to one state by a timing signal (TM) having an approximately constant cycle (T) and set to other state by the output of the comparator (CMP). An output signal (Q) of the latch (FF) is supplied to the switching driver (DRV) (refer to FIG. 5).

According to the above means according to the second present invention, the latch (FF) is set by the timing signal (TM) having the approximately constant cycle. Thus, the switching driver (DRV) controls the first switch element (M1) to an on state and controls the second switch element (M2) to an off state during a first period. Accordingly, current is supplied to the parallel connection of the smoothing capacitor (C1) and the load (ZL) from the input DC voltage (VIN) via the first switch element (M1) and the smoothing coil (L) during the first period, and energy is hence stored in the smoothing coil (L) during the first period. When the output voltage (Ve) of the error amplifier (EA) and the output signal (Vfb) of the feedback circuit (FBC) cross over, the output of the comparator (CMP) sets the latch (FF) to the other state. In doing so, the switching driver (DRV) controls the first switch element (M1) to an off state and controls the second switch element (M2) to an on state during a second period subsequent to the first period. Thus, a regenerative current used as an energy release current flows from the base potential via the second switch element (M1) and the smoothing coil (L) during the second period. Accordingly, a voltage drop that depends upon the ratio between the second period and the first period is developed, and hence the DC/DC converter performs the step-down operation. When the current flowing through the load (ZL) slightly increases with a variation in load, the amount of change in the output signal (Vfb) of the feedback circuit (FBC) during the second period also increases slightly. However, the output DC voltage (VOUT) supplied to the parallel connection of the smoothing capacitor (C1) and the load (ZL) is maintained approximately stably by negative feedback from the output signal (Vfb) of the feedback circuit (FBC) to the switching driver (DRV). According to the above means according to the second present invention, the level of noise can be reduced because a switching period corresponding to the sum of the first period and the second period is determined by the timing signal (TM) having the approximately constant cycle.

In addition, a specific form of the second present invention further includes an error voltage correcting circuit (EVCC). The error voltage correcting circuit includes a control switch (M3) controlled by the output (Q) of the latch (FF), and a control circuit (TG) which sets high impedance between the output of the error amplifier (EA) and the input of the comparator (CMP). A corrected output voltage (Vs) of the error voltage correcting circuit (EVCC) is generated from a common connecting point of the control switch (M3) and the control circuit (TG).

When an abnormal increase in load current occurs, the control switch (M3) and the control circuit (TG) are respectively controlled to an on state and a high impedance state by the output (Q) of the latch (FF). In doing so, the comparator (CMP) compares the corrected output voltage (Vs) set lower than the error output (Ve) of the error amplifier (EA), and the output signal (Vfb) of the feedback circuit (FBC)(refer to FIG. 8).

Advantageous effects obtained by representative ones of the inventions disclosed in the present application will briefly be explained as follows:

According to the first present invention, a semiconductor chip built-in circuit can be shared for a step-down function and a step-up function under one semiconductor product used as a DC/DC converter configured in a semiconductor chip.

Further, according to the second present invention, a response characteristic and a noise characteristic with respect to a variation in load current can be improved in a DC/DC converter.

### BRIEF DESCRIPTION OF THE DRAWINGS

FIG. 1 is a waveform diagram showing a circuit configuration and a circuit operation of a DC/DC converter according to one embodiment of a first present invention in a first operation mode (step-down output mode);

FIG. 2 is a waveform diagram illustrating a circuit configuration and a circuit operation of a DC/DC converter according to one embodiment of the first present invention in a second operation mode (step-up output mode);

FIG. 3 shows waveforms of respective circuit parts at the time that the DC/CC converter according to the one embodiment of the first present invention shown in FIG. 1 performs the first operation mode (step-down output mode);

FIG. 4 shows waveforms of the respective circuit parts at the time that the DC/DC converter according to the one embodiment of the first present invention shown in FIG. 2 performs the second operation mode (step-up output mode);

FIG. 5 is a circuit diagram showing a DC/DC converter according to one embodiment of a second present invention;

FIG. 6 is a waveform diagram for describing the operation of the DC/DC converter according to the one embodiment of the second present invention shown in FIG. 5;

FIG. 7 is a waveform diagram for describing the operation of the DC/DC converter shown in FIG. 5 in its overload state;

FIG. 8 is a circuit diagram showing a DC/DC converter according to an improved embodiment of the second present invention; and

FIG. 9 is a waveform diagram for describing the operation of the DC/DC converter according to the improved embodiment of the second present invention shown in FIG. 8.

### DETAILED DESCRIPTION OF THE PREFERRED EMBODIMENTS

<<Circuit Configuration of DC/DC Converter that Realizes Step-Down and Step-Up Functions>>

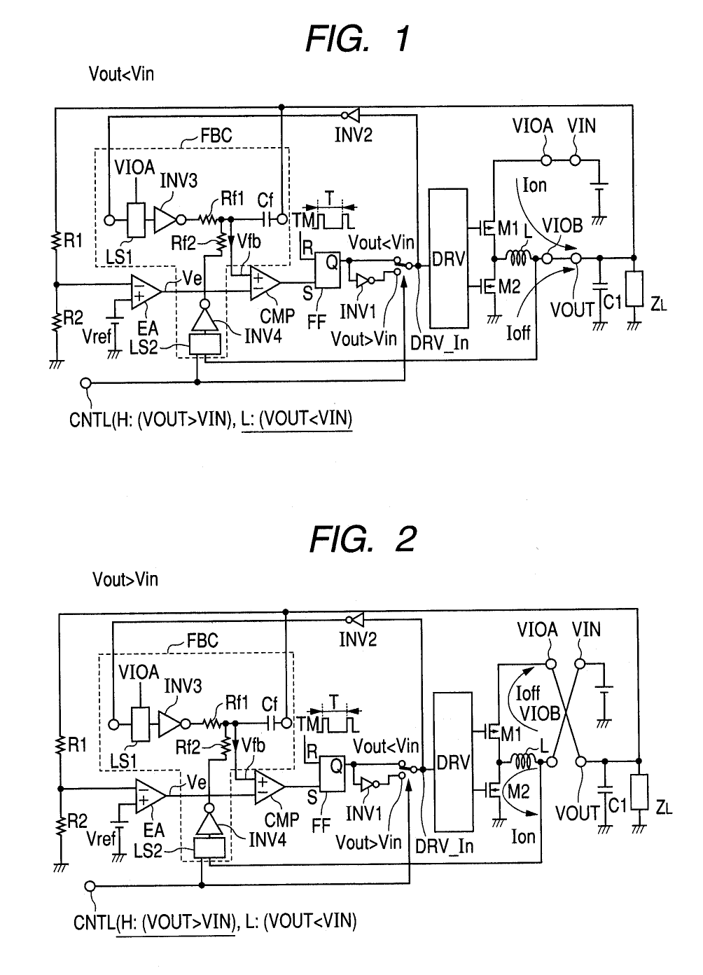

FIG. 1 is a diagram showing a circuit configuration in a first operation mode (step-down output mode), of a DC/DC converter according to one embodiment of a first present invention.

As shown in the same figure, a semiconductor chip for constituting the DC/DC converter includes a switching driver DRV, a first switch element M1 of a P channel MOS transistor driven by the switching driver DRV, and a second switching element M2 of an N channel MOS transistor driven thereby. An output current path of the first switch element M1 and an output current path of the second switch element M2 are connected in series. A common connecting point of the first switch element M1 and the second switch element M2 is adapted so as to be connected to one end of a smoothing coil L outside the semiconductor chip. As one example of its adaptation, the common connecting point is electrically connected to an external output terminal of the semiconductor chip. The other end of the output current path of the second switch element M2 is adapted so as to be connected to a base potential like, for example, a ground potential. As one example of its adaptation, the source or emitter of the second switch element M2 is electrically connected to an external ground terminal of the semiconductor chip.

In a mode in which the DC/DC converter performs the first operation mode (step-down output mode), a smoothing capacitor C1 and a load ZL are parallel-connected to the other end of the smoothing coil L outside the semiconductor chip as shown in FIG. 1. In the step-down operation mode, the output current path of the first switch element M1 is supplied with an input DC voltage VIN outside the semiconductor chip.

FIG. 3 shows waveforms of respective circuit parts at the time that the DC/DC converter according to the one embodiment of the first present invention shown in FIG. 1 performs the first operation mode (step-down output mode). In a mode in which the DC/DC converter performs its step-down operation, as shown in the same figure, the switching driver DRV controls the first switch element M1 to an on state, and controls the second switch element M2 to an off state (refer to M1 Gate and M2 Gate in FIG. 3) during a first period. Thus, as shown in FIG. 1, the parallel connection of the smoothing capacitor C1 and the load ZL is supplied with current from the input DC voltage VIN via the first switch element M1 and the smoothing coil L during the fist period, so that energy is stored in the smoothing coil L during the first period. Thus, a coil current given by the following equation flows during the first period.
ION=(VIN−VOUT)·t/L (3)

Incidentally, VIN indicates an input DC voltage supplied from an input DC voltage supply terminal TIN, VOUT indicates an output DC voltage from a DC output terminal TOUT, t indicates time, and L indicates the inductance of the coil, respectively.

During a second period subsequent to the first period, the switching driver DRV controls the first switch element M1 to an off state and controls the second switch element M2 to an on state. Thus, a regenerative current used as an energy release current flows from the base potential via the second switch element M2 and the smoothing coil L during the second period. Accordingly, a coil current given by the following equation flows during the second period.
IOFF=VOUT·t/L (4)

Incidentally, VON indicates a terminal-to-terminal on voltage of a third switch S3 placed in an on state, and t indicates time, respectively.

Assume that the length of the time t of the first period is TON and the length of the time t of the second period is TOFF. In doing so, the current given by the equation (3) and the current given by the equation (4) should be made equal to each other at the boundary between the first period and the second period. Thus, the following equation is obtained as follows:
(VIN−VOUT)·TON/L=VOUT·TOFF/L (5)

Expanding the equation (5) yields the following equation (6).
VOUT=VIN·TON/(TON+TOFF) (6)

It can thus be understood that in the first operation mode (step-down output mode), an output DC voltage VOUT lower than the input DC voltage VIN supplied from the input DC voltage supply terminal TIN can be outputted from the DC output terminal TOUT in accordance with the equation (6). Thus, a drop in voltage that depends upon the ratio between the second period TOFF and the first period TON occurs and hence the DC/DC converter shown in FIG. 1 performs the step-down operation.

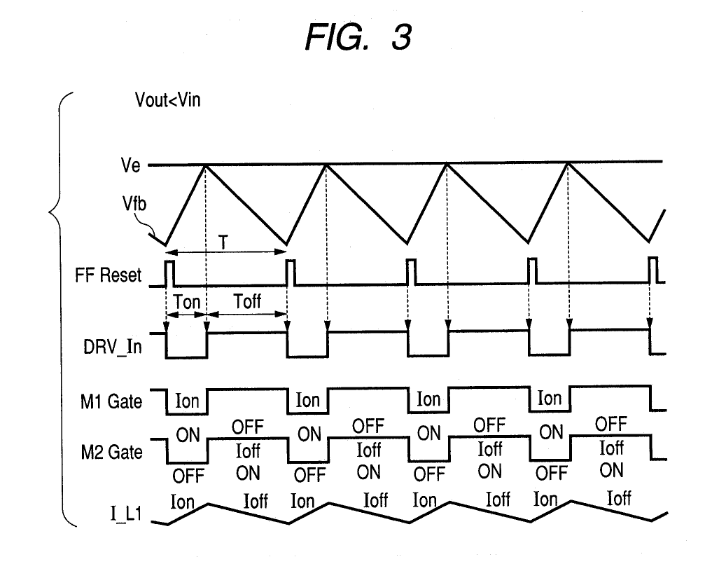

FIG. 2 is a diagram showing a circuit configuration in a second operation mode (step-up output mode), of a DC/DC converter according to one embodiment of the first present invention.

As shown in the same figure, a semiconductor chip for constituting the DC/DC converter includes a switching driver DRV, a first switch element M1 of a P channel MOS transistor driven by the switching driver DRV, and a second switching element M2 of an N channel MOS transistor driven thereby. An output current path of the first switch element M1 and an output current path of the second switch element M2 are connected in series. A common connecting point of the first switch element M1 and the second switch element M2 is adapted so as to be connected to one end of a smoothing coil L outside the semiconductor chip. The output current path of the second switch element M2 is adapted so as to be connected to a base potential like, for example, a ground potential. The circuit configuration and connection of FIG. 2 explained up to now are exactly equal to FIG. 1.

However, in a mode in which the DC/DC converter performs a step-up operation, the other end of the smoothing coil L is supplied with an input DC voltage VIN outside the semiconductor chip as shown in FIG. 2. In the step-up operation mode, a smoothing capacitor C1 and a load ZL are parallel-connected to the output current path of the first switch element M1 outside the semiconductor chip. This point is a difference between the circuit configuration and connection of FIG. 2 and those of FIG. 1.

Further, FIGS. 2 and 1 are different from each other in terms of on/off control of the first and second switch elements M1 and M2 by the switching driver DRV.

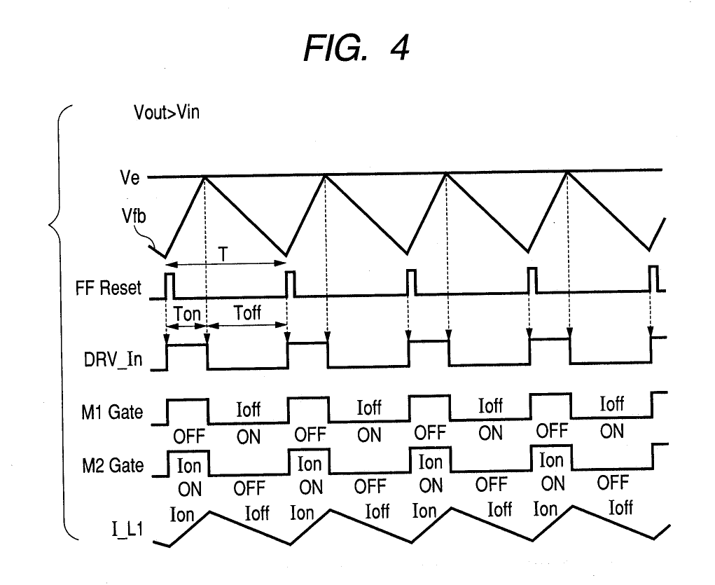

FIG. 4 shows waveforms of respective circuit parts at the time that the DC/DC converter according to the one embodiment of the first present invention shown in FIG. 2 performs the second operation mode (step-up output mode). In a mode in which the DC/DC converter performs its step-up operation, as shown in the same figure, the switching driver DRV controls the first switch element M1 to an off state, and controls the second switch element M2 to an on state during a first period. Thus, the current flows from the input DC voltage VIN to the base potential via the smoothing coil L and the second switch element M2 during the first period, so that energy is stored in the smoothing coil L during the first period. Accordingly, a coil current given by the following equation flows to the ground potential via the coil.
ION=VIN·t/L (7)

During a second period subsequent to the first period, the switching driver DRV controls the first switch element M1 to an on state and controls the second switch element M2 to an off state. Thus, a regenerative current used as an energy release current flows from the input DC voltage VIN to the parallel connection of the smoothing capacitor C1 and the load ZL via the smoothing coil L and the first switch element M1 during the second period. Accordingly, a coil current given by the following equation flows into its corresponding DC output terminal TOUT via the coil and the first switch element M1.
IOFF=(VIN−VOUT)·t/L (8)

Assume that the length of the time t of the first period is TON and the length of the time t of the second period is TOFF. In doing so, the current given by the equation (7) and the current given by the equation (8) should be made equal to each other at the boundary between the first period and the second period. Thus, the following equation is obtained as follows:
VIN·TON/L=(VIN−VOUT)·TOFF/L (9)

Expanding the equation (9) yields the following relationship.
VOUT=(1+(TON/TOFF)))·VIN (10)

It can thus be understood that in the second operation mode (step-up output mode), an output DC voltage VOUT higher than the input DC voltage VIN supplied from the input DC voltage supply terminal TIN can be outputted from the DC output terminal TOUT in accordance with the equation (10). Thus, a voltage obtained by superimposing-released or emission energy on the input DC voltage VIN is supplied to the parallel connection during the second period. Accordingly, an increase in voltage that depends upon the ratio between the second period TOFF and the first period TON occurs and hence the DC/DC converter performs the step-up operation.

According to the above one embodiments of the first present invention as described above using FIGS. 1, 2, 3 and 4, the connection form between the input DC voltage VIN and the parallel connection of the smoothing capacitor C1 and the load ZL at the outside of the semiconductor chip is changed, and the switching operation of the switching driver DRV is further changed. Thus, the switching driver DRV, the first switch element M1 and the second switch element M2 lying inside the semiconductor chip can contribute to both the step-down and step-up operations.

In a more specific embodiment of the first present invention, there has been adopted a technique for allowing an initially stabilized output DC voltage to follow an output voltage at high speed even upon a variation in load due to a variation in current flowing through a driven load ZL. A feedback circuit FBC in the circuit shown in each of FIGS. 1 and 2 is the core of such an adopted technique. The feedback circuit FBC essentially includes a feedback capacitor or capacitance Cf whose one end is supplied with the output DC voltage VOUT supplied to the parallel connection of the smoothing capacitor C1 and the load ZL. With the variation in the current flowing through the driven load ZL, the voltage at the other end of the feedback capacitance Cf changes. A change in the voltage at the other end of the feedback capacitance Cf is fed back to the input of the switching driver DRV so that the ratio between the first period TON and the second period TOFF is controlled, whereby the output DC voltage VOUT is held approximately constant. Upon the feedback of the feedback circuit FBC, the series connection of the feedback capacitance CF and a first feedback resistor Rf1 originally serves to detect a current flowing through the load ZL from the difference in potential across the smoothing coil L. However, according to the difference in potential due to this original connection, polarity is reversed in the case of the first operation mode (step-down output mode) and the second operation mode (step-up output mode). As already described above, the operations of performing on/off control of the first and second switch elements M1 and M2 by the switching driver DRV in the first operation mode (step-down output mode) and the second operation mode (step-up output mode) are reversed. The polarity of an input DRV_In of the switching driver DRV that responds to a feedback voltage Vfb supplied from the feedback circuit FBC is also reversed in the first operation mode (step-down output mode) and the second operation mode (step-up output mode).

In the first operation mode (step-down output mode) as shown in FIG. 1, an output Q of a latch FF that responds to the feedback voltage Vfb supplied from the feedback circuit FBC via a comparator CMP is supplied to the input DRV_In of the switching driver DRV without being reversed. A signal at the input DRV_In is supplied to one end of the first feedback resistor Rf1 via a second inverter IVN2, a first non-inversion level shift circuit LS1 and a third inverter INV3 in a non-inverted state. When the current flowing through the load ZL increases in the first operation mode (step-down output mode), it is necessary to increase the first period TON and reduce the second period TOFF in the meanwhile. With the action of the feedback capacitance Cf at this time, the first period TON increases whereas the second period TOFF decreases during a change cycle period of the feedback voltage Vfb supplied from the feedback circuit FBC. Thus, the output DC voltage VOUT is maintained approximately stably owing to the action of the feedback circuit FBC even depending on a current variation in load. In the first operation mode (step-down output mode), one end of a second feedback resistor Rf2 is maintained at a base potential like a ground potential by the output of a fourth inverter INV4 and becomes almost irrelevant to the voltage at the other end of the smoothing coil L. This is because a second non-inversion level shift circuit LS2 that responds to a control signal CNTL controls the fourth inverter INV4 as described above. Incidentally, the output DC voltage VOUT supplied to the parallel connection of the smoothing capacitor C1 and the load ZL as shown in FIG. 1 is divided by division resistors R1 and R2. The so-divided voltage is supplied to an inversion input terminal of an error amplifier EA, and a reference voltage Vref is supplied to a non-inversion input terminal of the error amplifier EA. The output of the error amplifier EA is supplied to an inversion input terminal of the comparator CMP, and the feedback voltage Vfb outputted from the feedback circuit FBC is supplied to a non-inversion input terminal of the comparator CMP. The output of the comparator CMP is supplied to a set input S of the latch FF, and a timing signal TM having an approximately constant cycle or period T is supplied to a reset input R of the latch FF. Thus, when the latch FF is reset by the timing signal TM as shown in FIG. 3, the output signal Q of the latch FF becomes low in level. In doing so, the input DRV_In of the switching driver DRV becomes a low level so that the switching driver DRV controls the first switch element M1 to an on state and controls the second switch element M2 to an off state. Thus, the operation corresponding to the first period during which energy is stored in the smoothing coil L is performed. When the feedback voltage Vfb supplied from the feedback circuit FBC slightly rises from the output Ve of the error amplifier EA, the output of the comparator CMP becomes high in level. The latch FF is set by the high-level output of the comparator CMP, so that the output signal Q becomes high in level. In doing so, the input DRV_In of the switching driver DRV is brought to a high level so that the switching driver DRV controls the first switch element M1 to an off state and controls the second switch element M2 to an on state. Thus, the operation corresponding to the second period during which energy is released from the smoothing coil L is performed.

On the other hand, in the second operation mode (step-up output mode) as shown in FIG. 2, an output Q of a latch FF that responds to the feedback voltage Vfb supplied from the feedback circuit FBC via a comparator CMP is inverted by a first inverter INV1, which in turn is supplied to the input DRV_In of the switching driver DRV. A signal at the input DRV_In is supplied to one end of the first feedback resistor Rf1 via a second inverter IVN2, a first non-inversion level shift circuit LS1 and a third inverter INV3 in a non-inverted state. When the current flowing through the load ZL increases in the second operation mode (step-up output mode), it is necessary to increase the first period TON and reduce the second period TOFF in the meanwhile in a manner similar to the first operation mode (step-down output mode). With the action of the feedback capacitance Cf at this time, the first period TON increases whereas the second period TOFF decreases during a change cycle period of the feedback voltage Vfb supplied from the feedback circuit FBC. Thus, the output DC voltage VOUT is maintained approximately stably owing to the action of the feedback circuit FBC even depending on a current variation in load. In the second operation mode (step-up output mode), the output DC voltage VOUT is also lowered with a reduction in transient input DC voltage VIN as is apparent from the equation (10). In order to lighten it, one end of a second feedback resistor Rf2 is supplied with the corresponding input DC voltage VIN by the output of a fourth inverter INV4. This is because a second non-inversion level shift circuit LS2 that responds to a control signal CNTL controls the fourth inverter INV4 as described above. When the input DC voltage VIN is reduced, a DC component of the feedback voltage Vfb supplied from the feedback circuit FBC is also reduced with the action of the second feedback resistor Rf2. Thus, the first period TON increases whereas the second period TOFF decreases during the change cycle period of the feedback voltage Vfb. As a result, the output DC voltage VOUT is maintained approximately stably. Incidentally, the output DC voltage VOUT supplied to the parallel connection of the smoothing capacitor C1 and the load ZL as shown in FIG. 2 is divided by division resistors R1 and R2. The so-divided voltage is supplied to an inversion input terminal of an error amplifier EA, and a reference voltage Vref is supplied to a non-inversion input terminal of the error amplifier EA. The output of the error amplifier EA is supplied to an inversion input terminal of the comparator CMP, and the feedback voltage Vfb outputted from the feedback circuit FBC is supplied to a non-inversion input terminal of the comparator CMP. The output of the comparator CMP is supplied to a set input S of the latch FF, and a timing signal TM having an approximately constant cycle or period T is supplied to a reset input R of the latch FF. Thus, when the latch FF is reset by the timing signal TM as shown in FIG. 4, the output signal Q of the latch FF becomes low in level and the output of the inverter INV1 becomes high in level. In doing so, the input DRV_In of the switching driver DRV becomes a high level so that the switching driver DRV controls the first switch element M1 to an off state and controls the second switch element M2 to an on state. Thus, the operation corresponding to the first period during which energy is stored in the smoothing coil L is performed. When the feedback voltage Vfb supplied from the feedback circuit FBC slightly rises from the output Ve of the error amplifier EA, the output of the comparator CMP becomes high in level. The latch FF is set by the high-level output of the comparator CMP, so that the output signal Q becomes high in level and the output of the inverter INV1 becomes low in level. In doing so, the input DRV_In of the switching driver DRV is brought to a low level so that the switching driver DRV controls the first switch element M1 to an on state and controls the second switch element M2 to an off state. Thus, the operation corresponding to the second period during which energy is released from the smoothing coil L is performed.

<<DC/DC Converter that Improves Response and Characteristics with Respect to Variation in Load Current>>

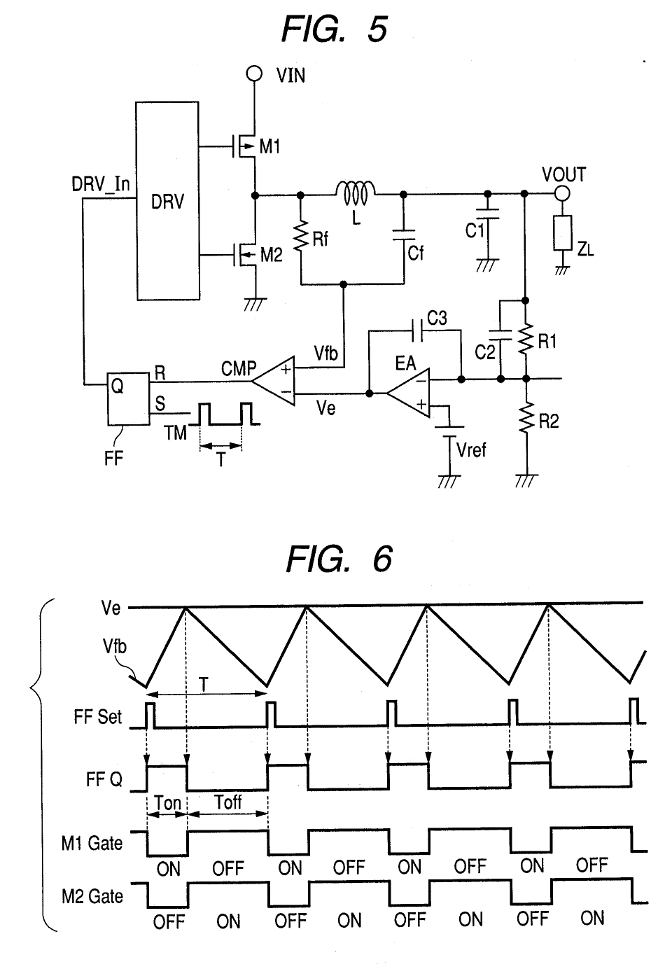

FIG. 5 is a circuit diagram showing a DC/DC converter according to one embodiment of a second present invention. Incidentally, FIG. 6 is a waveform diagram for describing the operation of the DC/DC converter according to the one embodiment of the second present invention shown in FIG. 5.

The DC/DC converter includes inside a semiconductor chip, a switching driver DRV, and a first switch element M1 and a second switch element M2 driven by the switching driver DRV. An output current path of the first switch element M1 and an output current path of the second switch element M2 are connected in series. A common connecting point of the first switch element M1 and the second switch element M2 is adapted so as to be connected to one end of a smoothing coil L. As one example of its adaptation, the common connecting point is electrically connected to an external output terminal of the semiconductor chip. The output current path of the first switch element M1 is supplied with an input DC voltage VIN. The output current path of the second switch element M2 is adapted so as to be connected to a base potential. As one example of its adaptation, the source or emitter of the second switch element M2 is electrically connected to an external ground terminal of the semiconductor chip. A smoothing capacitor C1 and a load ZL are parallel-connected to the other end of the smoothing coil L outside the semiconductor chip. The DC/DC converter further includes an error amplifier EA, a feedback circuit FBC, a comparator CMP, and a latch FF. The error amplifier EA detects an error of an output DC voltage VOUT supplied to the parallel connection of the smoothing capacitor C1 and the load ZL. The feedback circuit FBC includes a feedback capacitor or capacitance Cf whose one end is connected to the other end of the smoothing coil L, and a feedback resistor or resistance Rf of which one end is connected to the other end of the feedback capacitance Cf and the other end is connected to the one end of the smoothing coil L. The comparator CMP compares a signal that responds to the output of the error amplifier EA, and a signal outputted from the feedback circuit FBC. The latch FF is set by a timing signal TM having an approximately constant cycle or period T and reset by the output of the comparator CMP, and its output signal Q of the latch FF is supplied to the switching driver DRV.

In the DC/DC converter according to the one embodiment of the second present invention shown in FIG. 5, the latch FF is set by the timing signal TM having the approximately constant cycle T. Thus, the switching driver DRV controls the first switch element M1 to an on state and controls the second switch element M2 to an off state during a first period. Accordingly, current is supplied to the parallel connection of the smoothing capacitor C1 and the load ZL from the input DC voltage VIN via the first switch element M1 and the smoothing coil L during the first period, and hence energy is stored in the smoothing coil L during the first period. When the output Ve of the error amplifier EA and the output signal Vfb of the feedback circuit FBC cross over, the output of the comparator CMP resets the latch FF. In doing so, the switching driver DRV controls the first switch element M1 to an off state and controls the second switch element M2 to an on state during a second period subsequent to the first period. Thus, a regenerative current used as an energy release current flows from the base potential via the second switch element M1 and the smoothing coil L during the second period. Accordingly, a voltage loss that depends upon the ratio between the second period and the first period occurs, and the DC/DC converter performs the step-down operation. When the current flowing through the load ZL slightly increases with a variation in load, the amount of change in the output signal Vfb of the feedback circuit FBC during the second period also increases slightly. However, the output DC voltage VOUT supplied to the parallel connection of the smoothing capacitor C1 and the load ZL is maintained approximately stably by negative feedback from the output signal Vfb of the feedback circuit FBC to the switching driver DRV. Thus, since a switching period corresponding to the sum of the first period and the second period is decided by the timing signal TM having the approximately constant cycle T, the level of noise can be reduced.

Incidentally, the output DC voltage VOUT supplied to the parallel connection of the smoothing capacitor C1 and the load ZL as shown in FIG. 5 is divided by division resistors R1 and R2. The so-divided voltage is supplied to an inversion input terminal of the error amplifier EA, and a reference voltage Vref is supplied to a non-inversion input terminal of the error amplifier EA. The output of the error amplifier EA is supplied to an inversion input terminal of the comparator CMP, and the feedback voltage Vfb outputted from the feedback circuit FBC is supplied to a non-inversion input terminal of the comparator CMP. The output of the comparator CMP is supplied to a reset input R of the latch FF, and the timing signal TM having the approximately constant cycle or period T is supplied to a set input S of the latch FF. Thus, when the latch FF is reset by the timing signal TM as shown in FIG. 6, the output signal Q of the latch FF becomes high in level. In doing so, an input DRV_In of the switching driver DRV becomes a high level so that the switching driver DRV controls the first switch element M1 constituted of a P channel MOS transistor to an on state and controls the second switch element M2 constituted of an N channel MOS transistor to an off state. Thus, the operation corresponding to the first period during which energy is stored in the smoothing coil L is performed. When the feedback voltage Vfb supplied from the feedback circuit FBC slightly rises from the output Ve of the error amplifier EA, the output of the comparator CMP becomes high in level. The latch FF is reset by the high-level output of the comparator CMP, so that the output signal Q becomes low in level. In doing so, the input DRV_In of the switching driver DRV is brought to a low level so that the switching driver DRV controls the first switch element M1 to an off state and controls the second switch element M2 to an on state. Thus, the operation corresponding to the second period during which energy is released from the smoothing coil L is performed.

On the other hand, the present inventors have discussed in detail the DC/DC converter according to the one embodiment of the second present invention shown in FIG. 5. As a result, the following points have been manifested.

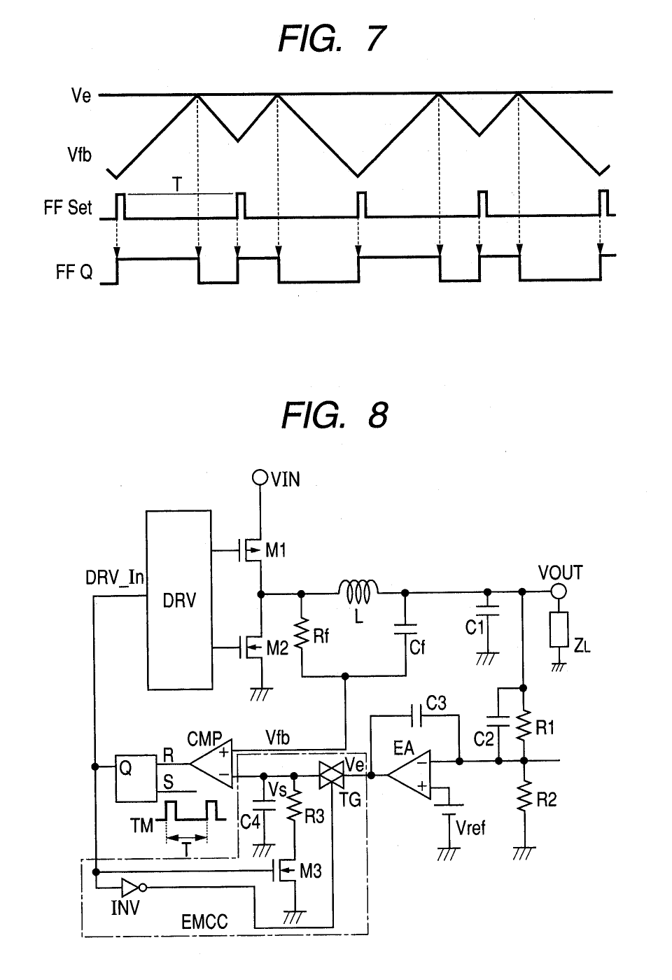

The following matters occur when the current flowing through the load ZL of the DC/DC converter shown in FIG. 5 becomes an abnormally large current. As shown in FIG. 7, the rise in the feedback voltage Vfb supplied from the feedback circuit FBC with respect to the output Ve of the error amplifier EA is delayed due to an abnormal increase in load current. During the first period in which this delay is being made, the first switch element M1 is controlled to an on state to compensate for a reduction in the output DC voltage VOUT supplied to the load ZL. At the end of such a first period, the feedback voltage Vfb outputted from the feedback circuit FBC becomes higher than the output Ve of the error amplifier EA, so that the latch FF is reset by the high-level output of the comparator CMP. In doing so, the second period is reached and hence the switching driver DRV controls the first switch element M1 to an off state and controls the second switch element M2 to an on state. Thus, the operation for the second period during which energy is released from the smoothing coil L, is performed. As shown in FIG. 7, however, the second period is shortened due to the extension of the first period, and the latch FF is hence set by the timing signal TM having the constant cycle T under a level at which a reduction in the feedback voltage Vfb outputted from the feedback circuit FBC is insufficient. In doing so, the operation for the first period is started and the feedback voltage Vfb rises from its insufficient reduced level. Thus, the first period is shortened at this time, and the feedback voltage Vfb outputted from the feedback circuit FBC becomes higher than the output Ve of the error amplifier EA at the end of the shortened first period. Hence, the latch FF is reset by the high-level output of the comparator CMP. In doing so, the lengths of both the period during which the output Q (FFQ) of the latch FF shown in FIG. 7 is high in level, and its low level period become instable. During the shortened first period and the shortened second period in particular, the output Q of the latch FF contains a high frequency component. It is feared that the high frequency component leads to an abnormal oscillation operation of the DC/DC converter.

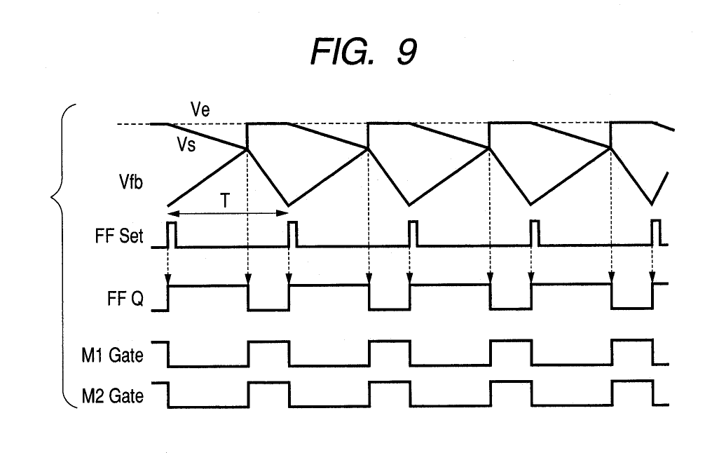

FIG. 8 is a circuit diagram showing a DC/DC converter according to an improved embodiment of the second present invention. Incidentally, FIG. 9 is a waveform diagram for describing the operation of the DC/DC converter according to the improved embodiment of the second present invention shown in FIG. 8.

The circuit shown in FIG. 8 is equivalent to one in which an error voltage correcting circuit EVCC is added to the circuit shown in FIG. 5. The error voltage correcting circuit EVCC shown in FIG. 8 essentially includes a control switch M3 controlled by an output Q of a latch FF, and a transmission gate TG configured as a circuit which brings the output of an error amplifier EA and the input of a comparator CMP to high impedance. A resistor R3 and a capacitor C4 of the error voltage correcting circuit EVCC are elements for adjusting the rate (discharge time constant) of change in output voltage Vs produced from the error voltage correcting circuit EVCC. An inverter INV of the error voltage correcting circuit EVCC is provided to bring the transmission gate TG constituted by a CMOS analog switch to high impedance when the output Q of the latch FF is rendered high in level.

FIG. 8 is a circuit diagram showing the DC/DC converter according to the improved embodiment of the second present invention. Let's assume that an abnormal increase in load current has occurred. In doing so, the latch FF is set by a timing signal TM and the output Q thereof is hence rendered high in level so that the operation for a first period is started. With a change of the output Q of the latch FF from a low level to a high level, the control switch M3 is controlled to an on state and the transmission gate TG is controlled to an off state corresponding to high impedance in the error voltage correcting circuit EVCC. In doing so, the output voltage Vs produced from the error voltage correcting circuit EVCC becomes lower than the error output Ve of the error amplifier EA as shown in FIG. 9. The comparator CMP is changed to the operation of comparing a feedback voltage Vfb outputted from a feedback circuit FBC and the output voltage Vs produced from the error voltage correcting circuit EVCC. Thus, even though a rise in the feedback voltage Vfb produced from the feedback circuit FBC is delayed due to the abnormal increase in load current, the output voltage Vs of the error voltage correcting circuit EVCC, which is intended for comparison by the comparator CMP is, also reduced. A change in the output voltage Vs is determined depending upon the resistor R3 and the capacitor C4. Thus, in the DC/DC converter according to the improved embodiment of the second present invention shown in FIG. 8, the significant extension of the first period shown in FIG. 7 is avoided, and the feedback voltage Vfb outputted from the feedback circuit FBC is reduced to a sufficient level.

While the invention made above by the present inventors has been described specifically on the basis of the preferred embodiments, the present invention is not limited to the embodiments referred to above. It is needless to say that various changes can be made thereto within the scope not departing from the gist thereof.

In the embodiment shown in FIG. 1, for example, the P channel MOS transistor M1 can be substituted with a PNP type bipolar transistor. The N channel MOS transistor M2 can be substituted with an NPN type bipolar transistor. Similarly, the P channel MOS transistor and N channel MOS transistor in the CMOS analog switch that constitutes the transmission gate TG shown in FIG. 8 can respectively be substituted with a PNP type bipolar transistor and an NPN type bipolar transistor.

The smoothing coil L of the DC/DC converter may be a spiral coil formed on a semiconductor chip by a semiconductor process in addition to an inductor element provided outside the chip. Alternatively, the smoothing coil L may be a coil lying inside a package, which makes use of part of a lead frame provided inside a package which seals a semiconductor chip.

1. A DC/DC converter comprising:
a semiconductor chip including a switching driver, and a first switch element and a second switch element driven by the switching driver,
wherein an output current path of the first switch element and an output current path of the second switch element are connected in series,
wherein a common connecting point of the first and second switch elements is adapted so as to be connected to one end of a smoothing coil outside the semiconductor chip,
wherein in a mode in which the DC/DC converter performs a step-down operation, a smoothing capacitor and a load are parallel-connected to the other end of the smoothing coil outside the semiconductor chip, and in the step-down operation mode, the output current path of the first switch element is supplied with an input DC voltage outside the semiconductor chip,
wherein in a mode in which the DC/DC converter performs a step-up operation, the other end of the smoothing coil is supplied with the input DC voltage outside the semiconductor chip, and in the step-up operation mode, the smoothing capacitor and the load are parallel-connected to the output current path of the first switch element outside the semiconductor chip,
wherein in the mode in which the DC/DC converter performs the step-down operation, the switching driver controls the first switch element to an on state and controls the second switch element to an off state during a first period, and the switching driver controls the first switch element to an off state and controls the second switch element to an on state during a second period subsequent to the first period, whereby the DC/DC converter performs the step-down operation, and
wherein in the mode in which the DC/DC converter performs the step-up operation, the switching driver controls the first switch element to an off state and controls the second switch element to an on state during the first period, and the switching driver controls the first switch element to an on state and controls the second switch element to an off state during the second period subsequent to the first period, whereby the DC/DC converter performs the step-up operation.

2. The DC/DC converter according to claim 1,
wherein in a mode in which the DC/DC converter performs a step-down operation, the switching driver controls the first switch element to an on state and controls the second switch element to an off state during a first period, whereby a current is supplied to a parallel connection of the smoothing capacitor and the load from the input DC voltage via the first switch element and the smoothing coil during the first period and energy is hence stored in the smoothing coil during the first period, and the switching driver controls the first switch element to an off state and controls the second switch element to an on state during a second period subsequent to the first period, whereby a regenerative current used as an energy release current flows from a base potential via the second switch element and the smoothing coil during the second period so that a voltage drop dependent on the ratio between the second period and the first period is developed, and hence the DC/DC converter performs the step-down operation, and
wherein in a mode in which the DC/DC converter performs a step-up operation, the switching driver controls the first switch element to an off state and controls the second switch element to an on state during a first period, whereby a current flows from the input DC voltage to a base potential via the second switch element and the smoothing coil during the first period and energy is hence stored in the smoothing coil during the first period, and the switching driver controls the first switch element to an on state and controls the second switch element to an off state during a second period subsequent to the first period, whereby a regenerative current used as an energy release current flows from the input DC voltage to the parallel connection of the smoothing capacitor and the load via the smoothing coil and the first switch element during the second period, so that a voltage obtained by superimposing released energy on the input DC voltage is supplied to the parallel connection during the second period, and a voltage increase dependent on the ratio between the second period and the first period is developed, and hence the DC/DC converter performs the step-up operation.

3. The DC/DC converter according to claim 1, further including a detection circuit which detects a variation in current flowing through the smoothing coil,
wherein the detection circuit includes a feedback capacitor having one end supplied with a DC output voltage supplied to the load, a first feedback resistor having one end connected to the other end of the feedback capacitor, and a second feedback resistor having one end connected to the other end of the feedback capacitor,
wherein an output voltage detected by the detection circuit is obtained from a common connecting point of the feedback capacitor, the first feedback resistor and the second feedback resistor, and the detected output voltage is fed back to the input of the switching driver,
wherein in the mode in which the DC/DC converter performs the step-down operation, a signal related to the input of the switching driver is supplied to the other end of the first feedback resistor, and a base potential is supplied to the other end of the second feedback resistor, and
wherein in the mode in which the DC/DC converter performs the step-up operation, a signal related to the input of the switching driver is supplied to the other end of the first feedback resistor, and a signal related to the input DC voltage is supplied to the other end of the second feedback resistor.

4. A DC/DC converter comprising:
a switching driver; and
a first switch element and a second switch element driven by the switching driver,
wherein an output current path of the first switch element and an output current path of the second switch element are connected in series,
wherein a common connecting point of the first switch element and the second switch element are adapted so as to be connected to one end of a smoothing coil,
wherein an input DC voltage is supplied to the output current path of the first switch element, and
wherein the output current path of the second switch element is adapted so as to be connected to a base potential, and
wherein a smoothing capacitor and a load are parallel-connected to the other end of the smoothing coil,
said DC/DC converter further comprising an error amplifier, a feedback circuit, a comparator, and a latch,
wherein the error amplifier detects an error of an output DC voltage supplied to the parallel connection of the smoothing capacitor and the load,
wherein the feedback circuit includes a feedback capacitor having one end connected to the other end of the smoothing coil, and a feedback resistor having one end connected to the other end of the feedback capacitor and the other end connected to the one end of the smoothing coil,
wherein the comparator compares a signal that responds to the output of the error amplifier and an output signal of the feedback circuit, and
wherein the latch is set to one state by a timing signal having an approximately constant cycle and set to other state by the output of the comparator, and an output signal of the latch is supplied to the switching driver.

5. The DC/DC converter according to claim 4, further including an error voltage correcting circuit,
wherein the error voltage correcting circuit includes a control switch controlled by the output of the latch, and a control circuit which sets high impedance between the output of the error amplifier and the input of the comparator,
wherein a corrected output voltage of the error voltage correcting circuit is generated from a common connecting point of the control switch and a gate, and
wherein when an abnormal increase in load current occurs, the control switch and the control circuit are respectively controlled to an on state and a high impedance state by the output of the latch, and the comparator compares the corrected output voltage set lower than the error output of the error amplifier, and the output signal of the feedback circuit.
